(19) United States
(12) Patent Application Publication
(10) Pub. No.: US 2022/0164902 A1
(43) Pub. Date: May 26, 2022

(54) AUTOMATED ENERGY TRADING SYSTEM FOR ENERGY STORAGE SYSTEMS

(71) Applicant: HAGAL TECHNOLOGY AS, Hokksund (NO)

(72) Inventor: Kent THORESEN, Hokksund (NO)

(73) Assignee: HAGAL TECHNOLOGY AS, Hokksund (NO)

(21) Appl. No.: 17/441,510

(22) PCT Filed: Mar. 23, 2020
(86) PCT No.: PCT/NO2020/050082

§ 371 Date: Sep. 21, 2021

(30) Foreign Application Priority Data
Mar. 22, 2019 (NO) 20190389

(51) Int. Cl. G06Q 50/06; G06Q 30/02

(52) U.S. Cl. CPC G06Q 50/06; G06Q 30/0283

(57) ABSTRACT

An energy storage system for automatically trading energy in a continuous fashion is disclosed. The system includes a power bank and a power participant. The power bank calculates optimized prices for buying and selling power and broadcasts them. When a power participant communicates that it wants to buy or sell power, the power is transferred. A number of system configurations were presented as to the power bank's position and role in a system. A method of automated energy trading with energy storage systems is also disclosed.

### BACKGROUND OF THE INVENTION

### Field of the Invention

The invention relates to energy trading systems in general, and more specifically an energy storage system and a method for automated energy trading with energy storage systems.

### Background

With electricity, there is usually an exact balance between generation and consumption because the electricity is not easily stored. A common practice in the electricity market is that prices are determined for each hour based upon bids, offers, and grid capacities of the previous 24-hour period. This is often referred to as the “day ahead market”. In many places (e.g. the EU), market participants can make bids and offers hour by hour for the next 24 hours, and do not need to reserve grid capacity in advance.

In addition to the day ahead market, there are intraday markets as well. In these markets, bids and offers are made for the next hour of power. One need for this is that conditions and expected power consumption change over the expected from 24 hours ago. Balancing markets are used to balance production and consumption due to events that occur within a specific hour. The prices are often calculated in a manual or slow manner. This leads to a loss of potential profits for a company and higher prices for the consumer.

The power grid can be very limited or completely absent in some locations. It can be a significant investment of time and money to supply power to these areas. As such, many areas with small numbers of inhabitants, limited needs, difficult to reach areas, and/or transitory needs are often neglected. It is also very difficult to get involved in the power market without significant start-up costs.

In the modern power market, renewable energy is very important for both the environment and the consumer. Several countries and regions give tax breaks to green energy. However, the price of electricity varies dramatically from hour to hour. This variation is in part predictable based on demand and in part unpredictable based on weather.

Green energy has not reached power grids everywhere. There are many factors for this. Some of them the infrastructure requirements, the fact that power companies have a monopoly over the types of energy being sold, how difficult it can be for a power company to obtain green energy in a reliable manner from other suppliers, and inefficient pricing strategies from power suppliers.

For example, in hydroelectric power stations it is common for power to be generated on demand when price is considered beneficial. Traditionally this was a manual process and based on long term contracts. This can make trading of green energy an inefficient process.

An electricity rate management system is known from EP2806393. This discloses a system comprising four distinct parties wherein a battery is provided at a renewable energy power generating facility. The battery is used to store surplus electricity generated from renewable energy where the stored energy can be counted as one originating from renewable energy.

A system and method for determining degradation of rechargeable lithium ion battery is known from US20130076363. This discloses degradation diagnosis based on an open circuit voltage characteristic of a rechargeable lithium ion battery indicating how the battery varies in open circuit voltage as the battery varies in capacity to obtain a capacity ratio of a positive electrode, a capacity ratio of a negative electrode, and a deviated capacity of the battery.

There is therefore a need for a method and a system to overcome the above-mentioned problems.

### SUMMARY OF THE INVENTION

### Problems to be Solved by the Invention

Therefore, an objective of the present invention is to provide a method for automatically trading energy for energy storage systems. An objective the present invention is the use mobile power banks to trade energy automatically. Another objective of the invention is to facilitate the introduction of green energy both to consumers and to wholesale power suppliers.

Other problems that the invention solves will be readily apparent to one skilled in the art.

### Short Summary of the Invention

In a first aspect, the present invention relates to an energy storage system comprising:
a power bank comprising:
   a price calculator to calculate a minimum acceptable sell price and a maximum acceptable purchase price based upon known factors, predictive factors, rapid response factors, and operational conditions of the power bank; and
   a battery bank to store and transmit the power that is being bought and sold;
   a charge state calculator to measure and/or calculate the current energy and power state of the power bank;
   a power transfer device to transfer power to and from the power bank;
   a broadcasting device to communicate information to and from the power bank;
   a decision device to make a decision based upon information from at least the charge state calculator and the price calculator if to transfer or receive power through the power transfer device;
a power participant; and wherein:
the power bank buys and/or sells power to the power participant autonomously at prices determined by the price calculator.

In an embodiment of the first aspect, the power participant in a power supplier which sells power to at least one customer.

In an embodiment of the first aspect, the power participant is an end user which does not sell power to a customer.

In an embodiment of the first aspect, the power bank sells power to customers.

In an embodiment of the first aspect, the power bank does not sell power.

In an embodiment of the first aspect, the power bank is mobile.

In an embodiment of the first aspect, the price calculations are occurring in a continuous manner.

In a second aspect, the present invention relates to a method of automated energy trading with energy storage systems comprising the steps of:
A. obtaining a power bank comprising:
   a charge state calculator to measure and/or calculate the current energy and power state of the power bank;
   a power transfer device to transfer power to and from the power bank;
   a broadcasting device to communicate information to and from the power bank;
   a price calculator to calculate a minimum acceptable sell price and maximum acceptable purchase price based upon known factors, predictive factors, rapid response factors, and operational conditions of the power bank; and
   a battery bank to store and transmit the power that is being bought and sold;
   a decision device to make a decision based upon information from at least the charge state calculator and the price calculator if to transfer or receive power through the power transfer device;
B. calculating storage capacity of the power bank;
C. calculating a buying and selling price for power involving the power bank;
D. broadcasting the amount of power available to purchase from the power bank and the selling price;
E. broadcasting the amount of power that the power bank can purchase and the buying price;
F. receiving offers from a power participant with an offer to buy or sell power at a given price from the power bank;
G. deciding if the offer is acceptable to the power bank, if acceptable then transferring power between the power participant and the power bank as appropriate;
H. repeating steps B-G in an autonomous manner.

In an embodiment of the second aspect, the power bank further comprises a battery wear calculator to calculate the conditions of the wear on the power bank during operation.

In an embodiment of the second aspect, step F further comprises the steps of:
F1. measuring of power demand on the power participant;
F2. calculating the surplus between what the current power stored by the power participant and the power demand on the power participant;
F3. predicting future power demand on the power participant;
F4. determining if the surplus is high enough to meet the expected future power demand;
F4A. offering to buy some power from the power bank if there is not enough surplus.

In an embodiment of the second aspect, step F4 further comprises the step of: F4B.

offering to sell some of the surplus power to the power bank if there is enough surplus.

In an embodiment of the second aspect, the power bank is connected to a power grid.

In an embodiment of the second aspect, the power bank is selling to a plurality of customers.

In an embodiment of the second aspect, the price calculations are performed continuously.

In an embodiment of the second aspect, the the power bank only buys power from the power participant.

In an embodiment of the second aspect, step G further comprises the step of G1: continuing to buy power if at an acceptable rate while the power is transferring between the power participant and the power bank.

In an embodiment of the second aspect, the invention further compromises a step F′ between step F and step G wherein the power bank continues to broadcast offers to buy and sell power with other power participants.

### BRIEF DESCRIPTION OF THE DRAWINGS

The above and further features of the invention are set forth with particularity in the appended claims. Together with advantages thereof, will become clearer from consideration of the following detailed description of an exemplary embodiment of the invention given with reference to the accompanying drawings.

The invention will be further described below in connection with exemplary embodiments, together with reference numbers, which are schematically shown in the drawings, wherein:

FIG. 1 discloses a number of embodiments of the invention

FIG. 2 discloses a schematic view of components of the power bank

FIG. 3A discloses a process diagram of an embodiment of the invention in configuration A

FIG. 3B discloses a process diagram of an alternative embodiment of the invention in configuration A

FIG. 3C discloses a process diagram for buying power while offing power for sale

FIG. 3D discloses a process diagram for buying power during delivery of power

FIG. 4 discloses a process diagram of an embodiment of the invention in configuration B

FIG. 5 discloses a process diagram of an embodiment of the invention in configuration C

FIG. 6 discloses a process diagram of an embodiment of the invention in configuration D

FIG. 7 discloses a process diagram of an embodiment of the invention in configuration E

FIG. 8 discloses a process diagram of an embodiment of the invention in configuration F

FIG. 9 discloses a process diagram of a way for the power bank to buy and sell power

FIG. 10 discloses a process diagram showing a general overview of the method of the system

| | |
|---|---|
| 10 | Power bank |
| 11 | Charge State Calculator |
| 12 | Power Transfer Device |
| 13 | Broadcasting Device |
| 14 | Battery Wear Calculator |
| 15 | Price Calculator |
| 16 | Decision device |
| 17 | Battery bank |
| 20 | End User |
| 30 | Power Supplier |
| 40 | Customer |
| 45 | Power Participant |
| 50 | Process for Buying Power While Selling Power |
| 51 | Process for Buying Power While Delivering Power |
| A | System where the Power bank Sells to an End User |
| B | System where the Power bank Buys and Sells with an End |
| | User |
| C | System where the Power bank Buys and Sells with a Power |
| | Supplier |
| D | System where the Power bank Only Uses its Own Power |
| E | System where the Power bank Sells to Directly to Customers |
| F | System where the Power bank Sells to a Power Supplier |

### DETAILED DESCRIPTION OF THE INVENTION

Various aspects of the disclosure are described more fully hereinafter with reference to the accompanying figures. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect of the disclosure disclosed herein might be embodied by one or more elements of a claim.

The present invention will make energy trading via mobile power banks, automatic and profitable. Market operators in the grid can then utilise this capacity to either balance the grid during peak demand or buy and sell power at different times. The system will automatically calculate short circuit currents for the connection it has to the grid and limit its energy flow to account for this if it limits the discharge rate for the battery against the grid.

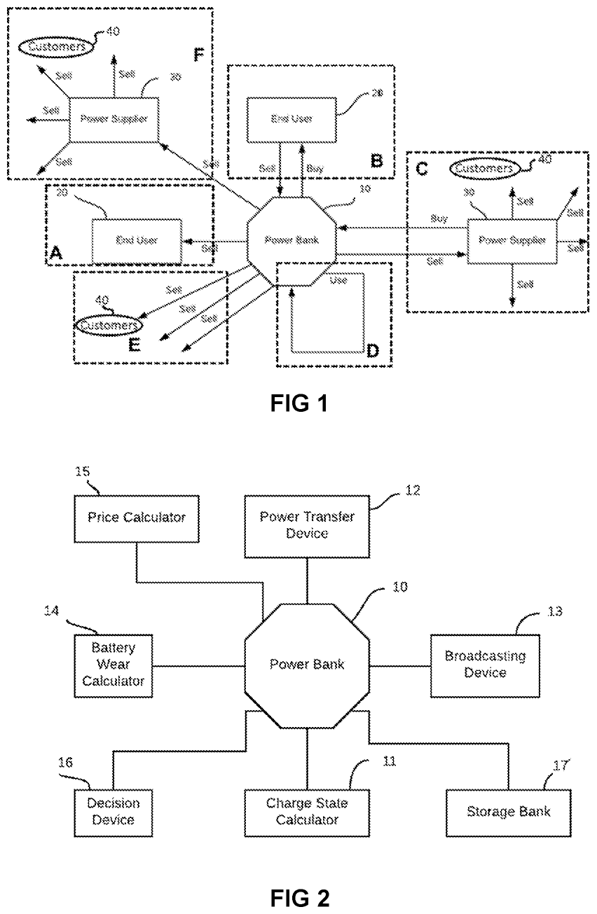

Reference is made to FIG. 1. FIG. 1 discloses a number of system configurations of how the power bank 10 of the present invention can be used. The power bank 10 is a device that comprises a number of elements, which are shown in FIG. 2 (and discussed later). The configuration A is when a power bank 10 is supplying power to an end user 20. In configuration B, the power bank 10 is both buying and selling power to the end user 20. Note that it is possible for configuration B to be used to buy from an end user 20 and not sell to that end user 20. In configuration C, the power bank 10 is buying and selling power to a power supplier 30; which is then selling the power to customers 40. In configuration D, the power bank 10 is buying from a power supplier 30 and consuming its own stored power. Configuration E shows where the power bank sells 10 directly to customers 40. Configuration F shows where the power bank 10 is selling to a power supplier 30 who then sells it onwards to customers 40.

It is preferable that the power bank 10 be mobile. The power grid can be very limited or completely absent in some locations and the mobility of the power bank 10 allows easy transportation of energy past such hurdles. By mobile it is meant that the power bank is 10 is transportable. Even though these power banks 10 can be large in order to supply the power demands needed in operation, they can still be transported as a unit or be broken down into some components. This is different from power suppliers 30 such as a power plant that has significant amounts of infrastructure associated with the production and transfer of power.

An end user 20 is a power consumer who is directly involved with the buying and selling of power involving the power bank 10. An end user 20 does not sell power onwards to another end user 20 and will normally consume at least a portion of the power themselves. A power supplier 30 is one who sells power onwards to customers 40. The definition of end user 20, power supplier 30, and customer 40 are from the power bank's position in the system. The term “power participant” 45 will be used where no distinction will be made between the end user 20 and the power supplier 30. In a general case both and user 20 and a power supplier 30 both receive and/transfer power with the power bank 10.

Note that FIG. 1 only covers the configurations where there is only one degree of separation from the power bank 10. There are many other possibilities when further degrees of separation are considered. For example in configuration A, the end user 20 can also buy more power from another power supplier 30 (later or at the same time) to supplement the power bank 10. In another example would be that the end user 20 of configuration B could then be a power supplier 30 with a power bank 10 for a group of customers. The new power bank 10 would then be in a system configuration E.

These are illustrative examples of configurations using the power bank 10 with a second degree of separation from the power bank 10 of the system. One skilled in the art would easily be able expand these configurations into several inter-related configurations. There are also embodiments of the power bank 10 that can be derived or expanded by one skilled in the art.

It is important that the overall system does not need to comprise a single configuration. The system can contain different configurations on the same power bank 10 at the same time. For example while the power bank 10 is selling power to an end user 20 as in configuration A, selling power to a power supplier 30 that will sell it on to customers 40 as in configuration F, buying and selling power involving a power supplier 30 as in configuration C.

The system will be able, in autonomous mode, to trade and buy based upon current diagnosis of all variables, market data prediction, and weather forecast. Customers can place an order for Power supply and the system automatically updates its trading variables.

Reference is made to FIG. 2. FIG. 2 discloses a schematic view of components of the power bank 10. In the preferred embodiment, the device comprises components of a charge state calculator 11, a power transfer device 12, a broadcasting device 13, a battery wear calculator 14, price calculator 15, decision device 16, and a battery bank 17. Preferably, the power bank 10 is used in an autonomous and continuous fashion. This allows for profits to be maximized and for a response to rapid changes in the power market.

A charge state calculator 11 is for measuring and/or calculating the current energy and power state of the power bank 10. This is normally done by measuring the battery bank 17. The device also measures, ambient temperature, cell temperature, cycle charge or discharge depth, speed of discharge, the historical use of the sell and the health of each individual cell, The device can also measure the grid and estimate the short circuit current in the local area on the grid.

A power transfer device 12 is for transferring power to and from the power bank 10. This is configured to be able to receive and send power to multiple places at the same time. It can be connected to the grid, not connected to the grid, or some of both. One skilled in the art will be able to make the adjustments and dimensioning necessary for the operational needs as required.

A broadcasting device 13 is for sending out and receiving information from other parts of the system. For example, the battery bank 17 can use it to communicate to another part of the system that it wants to buy power and at what price. This can done through a number of methods.

A battery wear calculator 14 is to take into account conditions that affect the ability of the battery to hold a charge. One factor in that a charge/discharge cycle will degrade the battery to a degree. It will also take into account that operation conditions, such as temperature, weather, system load spikes, and other known factors cause the battery's performance to change. This can be done by direct measurement of using test charges or measuring how long the same amount of charge is holding in the system or power bank 10. Additionally, models taking into account features such as operational loads, number of users 20 and power suppliers 30, weather, accidents, and other factors that can affect the battery performance can be used. It is also possible to use a combination of models and measurements.

A price calculator 15 is for calculating the optimal price to buy and sell power. This is important for maximizing profits. This will calculate the maximum price that the power bank 10 should buy power for and the minimum price it should sell power. In other words, this determines what prices are acceptable to buy and sell power.

A number of factors can be taken into account. For example, the price will vary with known factors, predictive factors, and rapid response factors. The known factors could include fixed contracts for delivering power and receiving power.

Predictive factors are those that are associated with predicting changing conditions. This can include looking at historical data on how much capacity a power supplier 30 needs in order to supply power to its customers 40. Additionally factors such as weather are important. For example, when it is cold, the price calculator 15 will predict an increase in power demand. On sunny and warm days, a solar farm will produce more power and on windy days, the wind farms will produce more power. By predicting wind speeds, it is possible to predict if the wind farms will need to shut down in the event of high winds. Data, for example weather, can either be predicted on the power bank 10 itself, or communicated to it locally or from offsite.

It will also evaluate the grid capacity where it is connected and all the market variables such as price and grid load at the time and create an automatic capacity offer specifying the cost to reserve or use the capacity at any point or length in time.

Rapid response factors are those that are related to short term or sudden changes in the market. For example, if the connection of a power supplier 30 to the grid is suddenly disrupted, this disruption can spread through all of the power suppliers 30 of the same company as they try to balance up the load. The price calculator would then adjust the price to account for the increase in demand.

The price calculator can also include information about that state of the battery from the charge state calculator 11 and/or battery wear calculator 14.

The price calculated does not have to be the same for each power participant 45. It can be modified by contract, location of the power participant 45, factors based upon variations in the conditions and market forces between the power bank 10 and the power participant 45, fees for using the grid, and other costs.

The decision device 16 is to process the information from the system (often from by broadcasting device 13), and from within elements of the power bank 10, evaluating the information from the charge state calculator 11, the battery wear calculator 14, and/or the price calculator 15. The decision device will then make a decision if to transfer or receive power through the power transfer device 12. The decision device can 16, among other things, decide if there is enough power to sell, if the power bank 10 has enough power to meet power commitments, if a power participant 45 is better to buy from or to sell to, and other decisions that the power bank 10 must perform.

It is possible for the decision device 16 to perform the decisions needed in more than one step. It is also possible for the decision device to first decide if the buy or sell power, and then to set a best price for it. This decision device 16 can be software or hardware with user specified behaviours. The decision device 16 can also use AI, machine learning, adaptive AI, or other methods wherein the system continues to learn and adapt based upon past performance and/or predicted future performance.

The battery bank 17 is to store and transmit the power that is being bought and sold. It can refer to a large or small collection of batteries of a large or small size. The battery bank 17 can be of different kinds of chemistry. Additionally, super capacitors or other methods for storing power could be used as well. The power bank 10 can comprise more than one type of battery. Second hand batteries such as those for ships and electric vehicles can also be used as part of a battery bank 17.

Embodiments can be comprised one or more of each component independently of each other. For example, it is possible to have embodiments that use more than one battery bank 17. Embodiments are possible where there are individual charge state calculators 11 and/or battery wear calculators on each battery. One skilled in the art will be able to build variations of the invention comprising at least some of the components.

It is possible to combine several of the elements mentioned into a single component. For example, the battery wear calculator 14, charge state calculator 11, price calculator 15, and the decision device 15 could be combined into a single device.

Note that the power bank 10 is meant to be performing in an autonomous way with frequent calculations based upon the variables at that moment. This would preferably occur in less than a second, most preferably less than 0.02 seconds.

However, depending on the costs of operating the components of the power bank 10, it may be more profitable to operate them with longer pauses in between updates.

In the preferred embodiment, the power bank 10 comprises a charge state calculator 11, a power transfer device 12, a broadcasting device 13, a battery wear calculator 14, price calculator 15, decision device 16, and a battery bank 17. However, some of these elements may not be necessary. For example. The battery wear calculator 14 could be left out.

Each of these components could can be software, hardware, or a combination of the two. These elements can be discreet portions of the power bank 10, or integrated components.

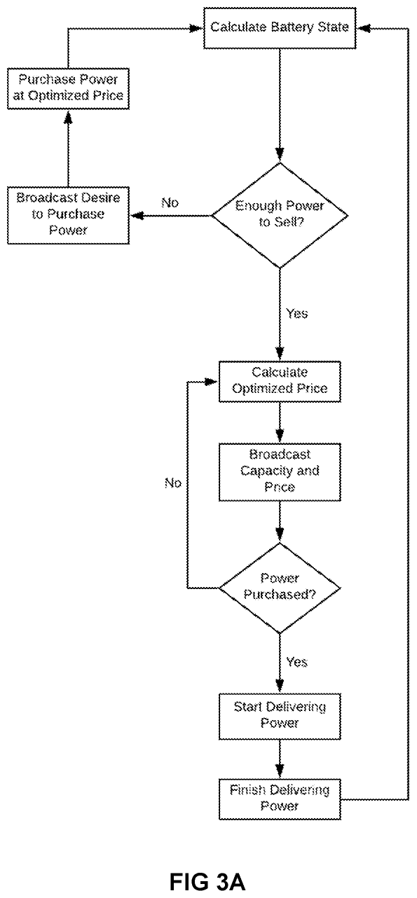

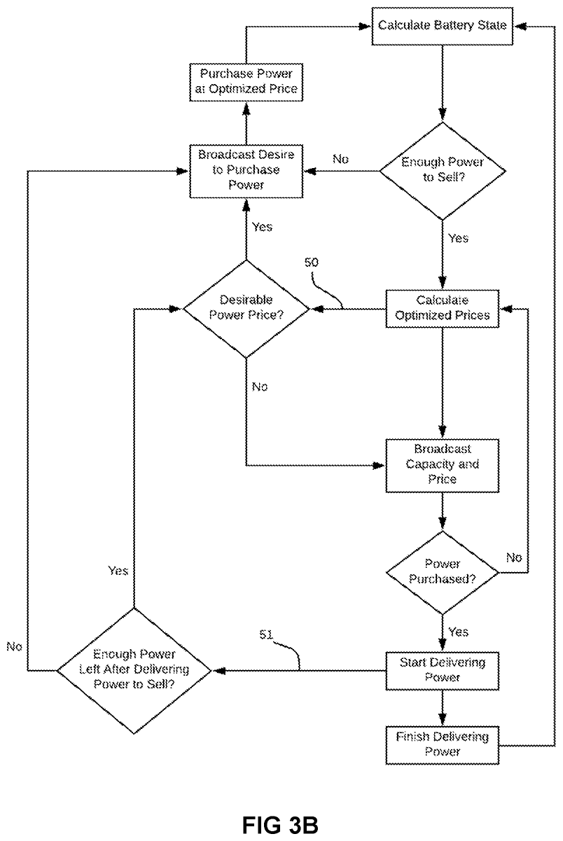

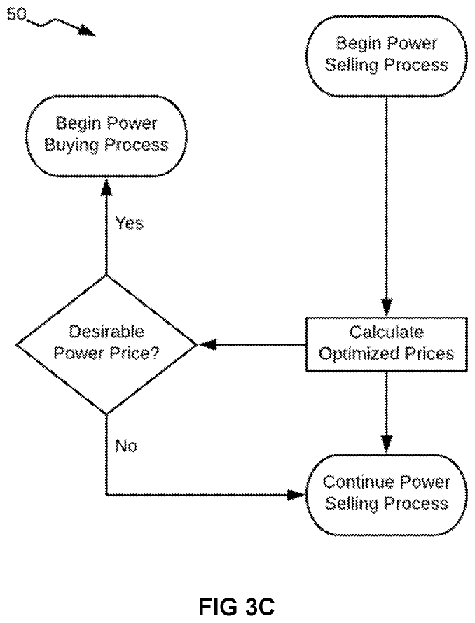

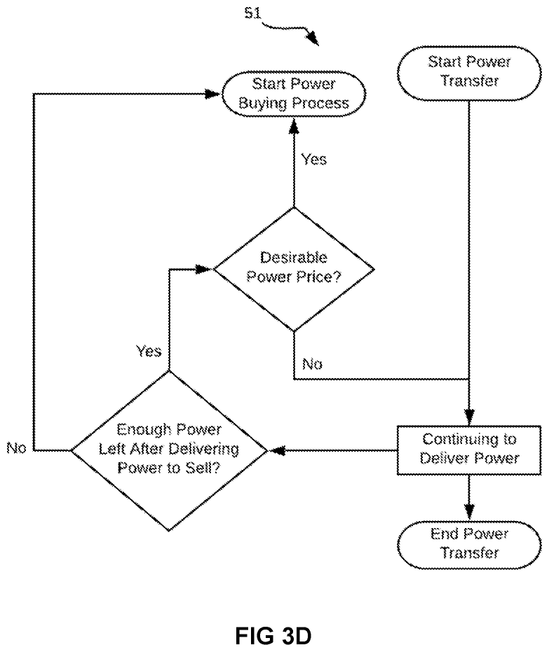

FIG. 3A to FIG. 9 disclose processes associated with the system configurations of A-F. In the discussion of FIG. 2, above, the function of each element of the power bank 10 was discussed.

The battery state of the battery is involved in most of the process disclosed in FIG. 3A to FIG. 9. This process finds the status and parameters that relate to the state of the power bank 10. For example, the charge state can be calculated by the charge state calculator 11 and/or the battery wear calculator 14 could calculate the parameters associated with battery wear.

For example in FIG. 3A, the battery state of the battery will be calculated. The decision device 16 will decide if there is enough power to sell. The price calculator 15 would then calculate the best sell price and broadcast, using the broadcasting device 13, this to potential buyers using the broadcast device 13. Once a buyer was found, the power transfer device 12 would transfer the power at the agreed upon price, then process would begin again with the calculation of the battery state. If the decision device 16 decided that there was not enough power to sell, it could broadcast using the broadcasting device that it desired to buy power. Power would then be transferred to the power bank 10 using the power transfer device 12.

Reference is made to FIG. 3A. FIG. 3A discloses a process diagram of when power bank 10 is supplying power to a power participant 45 (an end user 20 in this case) as in configuration A. The end user 20 in this does not sell the power back to the power bank 10. It is in configuration B that the end user 20 can sell power back to the power bank 10.

The power bank 10 will calculate the battery state using the charge state and optionally the amount of battery wear. If the power bank 10 has enough power to sell, it will calculate and broadcast the best possible price to sell the power. Once the power is purchased by a power participant 45 (end user 20 in configuration A), and the system will return to calculating the battery state, and the process will begin again.

Reference is made to FIG. 3B. FIG. 3B discloses a process diagram for an alternate embodiment of when the power bank 10 is supplying power to an end user 20 (configuration A). In FIG. 3A the battery 10, did not buy power until the system did not have enough power to sell. FIG. 3B provides a more profitable operation by changing when power for the power bank 10 is purchased (50). This process is also more profitable because it does not wait until the power is finished being delivered before buying more power, but continues to find buy power at a desired price while power is being delivered (51). Note that the process for buying power while transferring power (51) showed in FIG. 3B is an embodiment where the process is shown to begin only when the power transfer is initiated.

Reference is made to FIG. 3C. FIG. 3C discloses a process diagram for buying power while offing power for sale (50). After it is have been determined that there is enough power to sell, optimized prices for buying and selling power are determined. If the price for buying power is low enough, the system will then purchase power as well as continuing to offer it for sale.

This process of looking for power to buy at a low price even when having enough power to sell 50, can be included in the operation of all of these configurations that have been discussed in FIG. 1. One skilled in the art would be able to adjust these are needed.

Reference is made to FIG. 3D. FIG. 3D discloses a process diagram for buying power during delivery of power (51). Transferring power can take time depending upon operational conditions such as transfer speeds and the amount power being transferred. Unlike what is shown in FIG. 3B, the process of buying power when transferring power (51) is shown to occur continuously during the entirety of power transfer. It is not limited to when the transfer starts. This is a preferable embodiment of all of the systems when power transfer is occurring.

The process shown in FIG. 3D (51) opens up the possibility of selling power before the power transfer is completed. For example if there are two different power participants (45A and 45B) and the first one (45A) has purchased power that requires time to transfer, the power bank (10) does not need to keep the entire amount purchased stored in the storage bank (17). The power bank (10) can sell some power to the second power participant (45B), even if the total power stored in the power bank (10) is less than the amount of power that the first power participant (45A) has purchased, as long as the power bank (10) is able to buy more power during the power transfer (51).

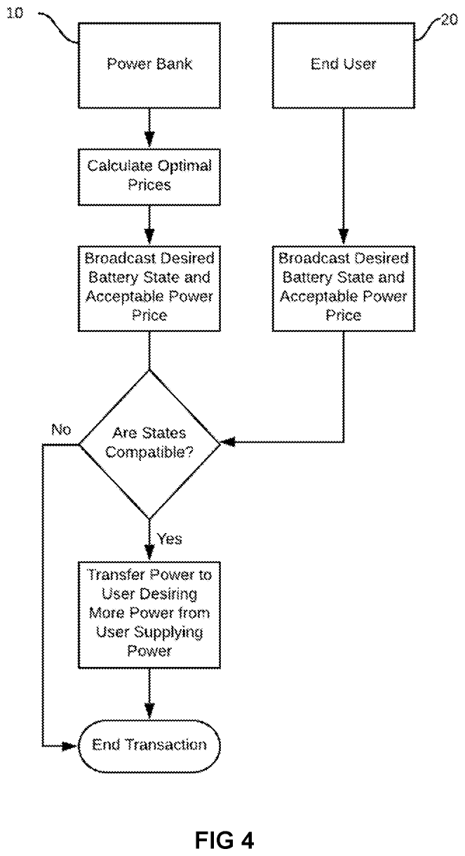

Reference is made to FIG. 4. FIG. 4 discloses a process diagram for system configuration B of where the power bank 10 is both buying and selling power to a power participant 45 (for example the end user 20). Please note that it is possible for the power bank 10 to buy power from the end user 20 but not sell to the end user 20.

In this process, the power bank 10 will calculate the battery state and optimal prices to buy or sell power. This is then broadcast to the end user 20. If these states are decided to be compatible (e.g. the end user 20 is willing to buy power at a price that the power bank 10 wants to sell), the power is transferred from the buyer to the seller.

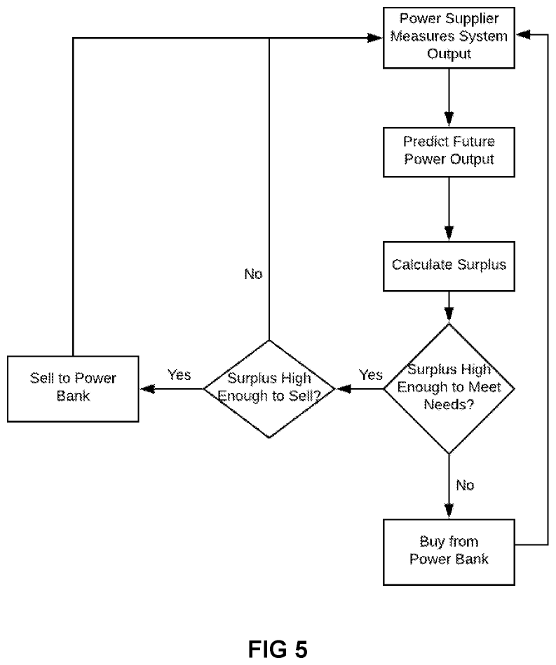

Reference is made to FIG. 5. FIG. 5 discloses a process diagram of where the power bank 10 is buying and selling power to a power participant 45 (configuration C). In this example, the power participant 45 is a power supplier 30, but an end user 20 could work instead. The power supplier 30 is selling power to customers 40.

In an example of this process, the power supplier 30 measures their current power output and predicts the future power output to find how much surplus power they have. If the power supplier 30 has enough surplus power to meet their customer's needs, then they can sell this to the power bank 10 if desired (and assuming that the power bank 10 is satisfied with the price). If the power supplier 30 does not have enough power to meet their needs, then they can buy power from the power bank 10. This allows a power bank 10 to balance the load for the power supplier 30.

Note that while FIG. 5 shows that the power supplier 30 starts the process with enough power to supply to customers 40. If this was not the case, then the power supplier 30 could buy the power from the power bank 10 (as in the last process shown at the bottom of FIG. 5).

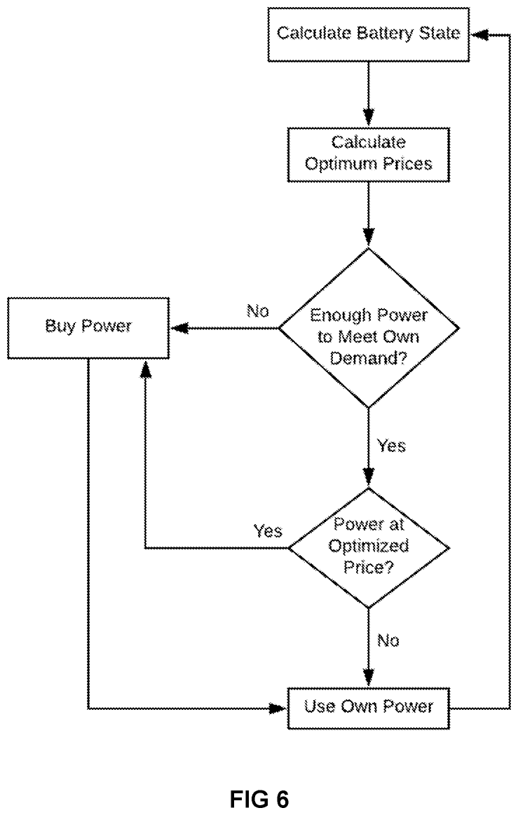

Reference is made to FIG. 6. FIG. 6 discloses a process diagram of where the power bank 10 is buying from a power supplier 30 and consuming its own stored power (configuration D). The only transfer of power if to the power bank 10 from power participants 45. The advantage of this is that the power bank 10 will have the best power price possible. A power bank 10 that can buy power from a power supplier 30 (or an end user 20) when the market price of power is acceptable.

In this process the power bank 10 will determine the battery state and the acceptable price for buying power. If the power bank 10 does not have enough power to meet demand, then it will purchase power from a power supplier 30 or end user 20. If the power bank 10 does have enough power, then it will still check if the price of buying power is acceptable. If so, then the power bank 10 will decide to buy the power.

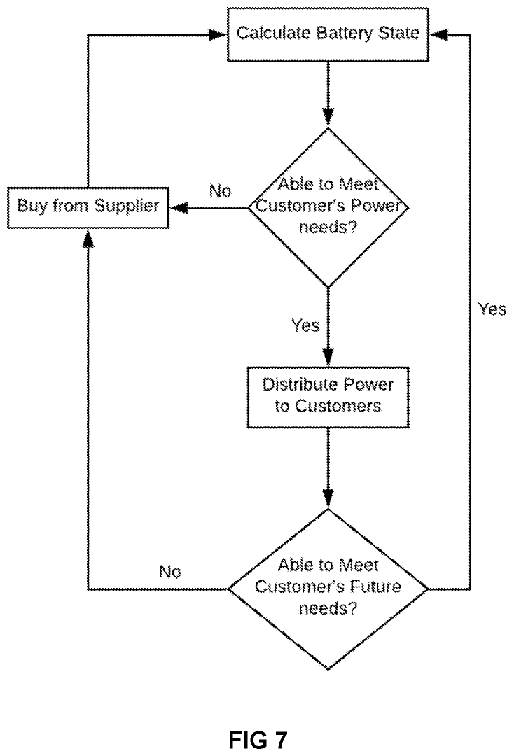

Reference is made to FIG. 7. FIG. 7 discloses a process diagram of where the power bank sells 10 directly to customers 40 (configuration E).

In this system configuration, the power bank 10 calculates the battery state and decides if it is able to meet the customers' 40 power needs. If so, then power is transferred to the customers 40. If not, then the power bank 10 will need to buy from a power participant 45 (a power supplier 30 and/or an end user 20).

While FIG. 7 shows that new power is only being purchased when the power bank 10 cannot supply power to the customers 40, it is more profitable if the price of power is constantly being monitored and compared against the power bank's acceptable power prices 50. An example of this was discussed in FIG. 3B.

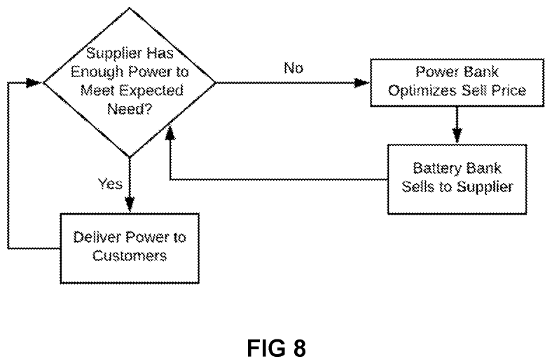

Reference is made to FIG. 8. FIG. 8 discloses a process diagram of where the power bank 10 is selling to a power supplier 30 who then sells it onwards to customers 40 (configuration F). This is the same as in system configuration C (see FIG. 5 and accompanying discussion), except that the power bank 10 is not purchasing power from the power supplier 30.

In an example of this process, the power supplier 30 measures their current power output and predicts the future power output to find how much surplus power they have. If the power supplier 30 has enough surplus power to meet their customer's needs, then the power supplier 30 would not need to interact with the power bank 10. However, if the power supplier 30 did not have enough power, then the power bank 10 would sell power to the power supplier.

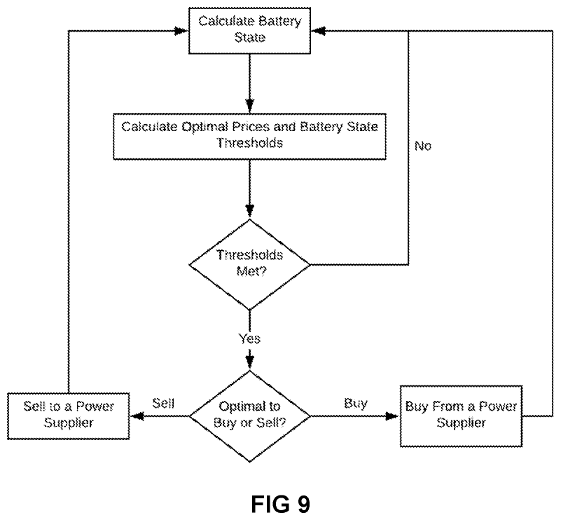

Reference is made to FIG. 9. FIG. 9 discloses a process diagram of a non-limiting example for the power bank 10 to buy and sell power. The battery state of the power bank 10 would first be determined. Then the optimized prices for buy and selling power could be determined. The power bank 10 would broadcast the prices it was willing to buy and sell power. If it found a power participant 45 that offered acceptable buying or selling prices, the system would make a decision and transfer power.

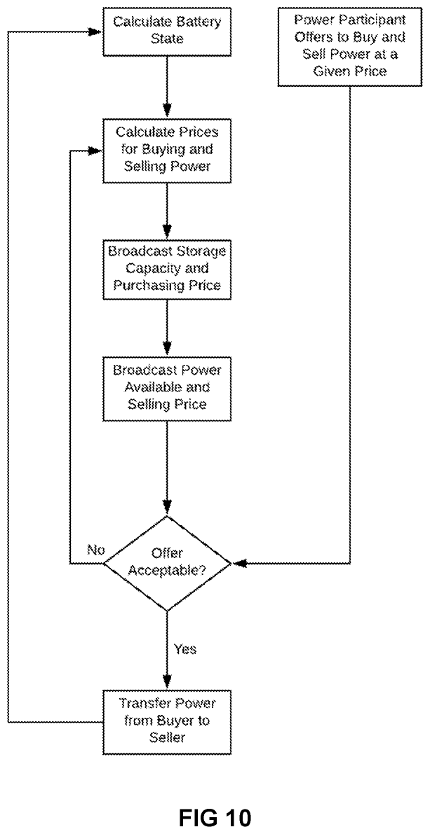

Reference is made to FIG. 10. FIG. 10 discloses a process diagram showing a general overview of the method of the system. The battery state is calculated as is the amount of power (available to sell or able to be purchased and stored) and the prices for buying and selling power. A power participant 45 broadcasts what kind of power transfer it is interested in (buying or selling) and the associated price. If the power bank find this acceptable, the transaction will occur. If not, then the prices are recalculated and rebroadcast. Configurations A-F are specific embodiments of this.

Please note that the process diagrams are for illustrative purposes. In several instances, the order of the process can change or new ones added depending on the needs of the system and operation conditions. An example of this is the routine 50 shown in FIG. 3B. Another example is in the process diagram of configuration C (FIG. 5), after the power supplier has decided if there is enough power to sell, the power bank can check if the price is acceptable. If not, then the power bank would simply refuse to sell. Another example is in the process diagram of configuration E (FIG. 7) if there is enough power to meet the customer's needs, it would be possible to check if the price of power was low enough to make it profitable to buy more power; despite there being enough power to meet demand.

Where possible, the power bank 10 will only buy power when the price is at or below the optimized price. Correspondingly, the power bank 10 will only sell power when the price is at or above the optimized price. This may not always be possible. For example when power will need to be purchased in order to meet the power banks 10 obligations. Another case would be if capital was needed in order to buy more power. Additionally, if the power bank 10 predicted that there would be a drastic drop in power price and wanted to sell large amount of power to “fill up” on as much cheap power as possible.

Please note that “step of” is not to be interpreted as “step for”. The terms “comprised of”, “comprising”, “comprises” etc. are referring to an open set and the term “consisting of” are referring to a closed set.

1. An energy storage system comprising:
a power bank comprising:
a price calculator to calculate a minimum acceptable sell price and a maximum acceptable purchase price based upon known factors, predictive factors, rapid response factors, and operational conditions of the power bank;
a battery bank to store and transmit the power that is being bought and sold;
a charge state calculator to measure and/or calculate the current energy and power state of the power bank;
a power transfer device to transfer power to and from the power bank;
a broadcasting device to communicate information to and from the power bank;
a decision device to make a decision based upon information from at least the charge state calculator and the price calculator if to transfer or receive power through the power transfer device; and
a power participant,
wherein the power bank buys and/or sells power to the power participant autonomously at prices determined by the price calculator.

2. The system according to claim 1, wherein the power participant is a power supplier which sells power to at least one customer.

3. The system according to claim 1, wherein the power participant is an end user which does not sell power to a customer.

4. The system according to claim 1, wherein the power bank sells power to customers.

5. The system according to claim 1, wherein the power bank does not sell power.

6. The system according to claim 1, wherein the power bank is mobile.

7. The system according to claim 1, wherein the price calculations are occurring in a continuous manner.

8. A method of automated energy trading with energy storage systems comprising the steps of:
A. obtaining a power bank comprising:
a charge state calculator to measure and/or calculate the current energy and power state of the power bank;
a power transfer device to transfer power to and from the power bank;
a broadcasting device to communicate information to and from the power bank;
a price calculator to calculate a minimum acceptable sell price and a maximum acceptable purchase price based upon known factors, predictive factors, rapid response factors, and operational conditions of the power bank;
a battery bank to store and transmit the power that is being bought and sold; and
a decision device to make a decision based upon information from at least the charge state calculator and the price calculator if to transfer or receive power through the power transfer device;
B. calculating storage capacity of the power bank;
C. calculating a buying and selling price for power involving the power bank;
D. broadcasting the amount of power available to purchase from the power bank and the selling price;
E. broadcasting the amount of power that the power bank can purchase and the buying price;
F. receiving offers from a power participant with an offer to buy or sell power at a given price from the power bank;
G. deciding if the offer is acceptable to the power bank, if acceptable then transferring power between the power participant and the power bank as appropriate; and
H. repeating steps B-G in an autonomous manner.

9. The method according to claim 8, wherein the power bank further comprises a battery wear calculator to calculate the conditions of the wear on the power bank during operation.

10. The method according to claim 8, wherein step F further comprises the steps of:
F1. measuring of power demand on the power participant;
F2. calculating the surplus between what the current power stored by the power participant and the power demand on the power participant;
F3. predicting future power demand on the power participant;
F4. determining if the surplus is high enough to meet the expected future power demand; and
F4A. offering to buy sonic power from the power bank if there is not enough surplus.

11. The method according to claim 10, wherein step F4 further comprises the step of: F4B. offering to sell some of the surplus power to the power bank if there is enough surplus.

12. The method according to claim 8, wherein the power bank is connected to a power grid.

13. The method according to claim 8, wherein the power bank is selling to a plurality of customers.

14. The method according to claim 8, wherein the price calculations are performed continuously.

15. The method according to claim 8, wherein the power bank only buys power from the power participant.

16. The method according to claim 8, wherein step G further comprises the step of G1: continuing to buy power if at an acceptable rate while the power is transferring between the power participant and the power bank.

17. The method according to claim 8, wherein the method further compromises a step F′ between step F and step G wherein the power bank continues to broadcast offers to buy and sell power with other power participants.

18. The system according to claim 2, wherein the power participant is an end user which does not sell power to a customer.

19. The system according to claim 2, wherein the power bank sells power to customers.

20. The system according to claim 3, wherein the power bank sells power to customers.
